(19) United States
(12) Patent Application Publication
(10) Pub. No.: US 2010/0079649 A1
(43) Pub. Date: Apr. 1, 2010

(54) IMAGE SENSOR SYSTEM WITH SYNCHRONIZED SWITHCED-MODE POWER SUPPLY

(75) Inventor: Michel AYRAUD, Voreppe (FR)

Correspondence Address: LOWE HAUPTMAN HAM & BERNER, LLP, 1700 DIAGONAL ROAD, SUITE 300, ALEXANDRIA, VA, 22314, US

(73) Assignee: E2V SEMICONDUCTORS, Saint Egreve (FR)

(21) Appl. No.: 12/565,843

(22) Filed: Sep. 24, 2009

(30) Foreign Application Priority Data
Sep. 26, 2008 (FR) 085311

(51) Int. Cl. H04N 5/335

(52) U.S. Cl. 348/308; 348/294; 348/E05.091

(57) ABSTRACT

The invention relates to an image sensor comprising an integrated circuit chip incorporating a matrix of rows and columns of photosensitive pixels and a read amplifier, the amplifier supplying successive signals representing the lighting of the different pixels of the image, with a pixel reading frequency determined by a system clock. The system is powered by a general power supply voltage and the read amplifier is powered by a stabilized power supply voltage supplied by a DC/DC voltage converter receiving the general power supply voltage. The DC/DC converter comprises a switched-mode power supply that uses a switch to chop a direct current at high frequency and a rectifier to rectify and filter the chopped current. The chopping frequency is the pixel reading frequency, which eliminates certain power supply-related noises that degrade the video signal.

### RELATED APPLICATIONS

The present application is based on, and claims priority from, French Application Number 08 05311, filed on Sep. 26, 2008, the disclosure of which is herby incorporate by reference herein in its entirety.

### FIELD OF THE INVENTION

The invention relates to electronic image-taking systems.

### BACKGROUND OF THE INVENTION

Such systems generally comprise an electronic card (more often than not a printed circuit) supporting:
an integrated circuit chip including a matrix of photosensitive elements; the matrix constitutes the core of this image-taking system and is intended to be placed in the focal plane of an optical system that projects an image onto the chip; in addition to the matrix, the chip includes matrix control circuits and circuits for reading the photosensitive charges generated by the light in each element of the matrix; the matrix can be reduced to one row or a few rows of photosensitive elements in the case of linear strips, but the term matrix will be used hereinbelow regardless of the number of rows;
various circuits necessary to the operation of the chip, notably including digital circuits producing digital signals for controlling the rows and columns of the matrix, clock circuits establishing a time reference common to the entire card, and electrical power supply circuits supplying the DC voltages necessary for the chip and the other circuits.

More often than not, the card is powered by a general electrical power supply voltage, for example at 9 or 12 volts, but the circuits of the card and of the chip may demand different power supply voltages, for example 3.3 volts for the digital circuits, 10 volts for certain circuits, 15 volts for the charge reading circuits of the chip. In this case, all these different power supply voltages are produced from the general power supply, and one or more DC/DC voltage converters (hereinafter referred to as DC/DC converters) are provided on the card to produce these various voltages.

The DC/DC converters can be linear analogue voltage regulators, but such regulators consume a lot of energy to maintain the desired stable voltage at their output; also they are bulky. DC/DC converters in the form of switched-mode power supplies are preferred because they consume little and use small components; a switched-mode power supply is, moreover, necessary if a higher voltage than the general power supply voltage has to be produced, for example 15 volts from 12 volts.

Switched-mode power supplies work using a switch that chops a DC input current at high frequency (typically a frequency from several tens of kHz to several megahertz); the current, chopped at a high frequency, is used to produce an alternating voltage at this frequency, and this alternating voltage can be processed, rectified and filtered; the switch that chops the voltage works with a fixed or variable duty cycle, defined by a control circuit, and the DC voltage output from the power supply depends on this duty cycle.

However, the well-known drawback of switched-mode power supplies is that they generate noise in the circuits because of the high frequency chopping operation. This noise affects the surrounding circuits.

In the case of image sensors, it has been observed in the past that the noise from the switched-mode power supplies of the electronic card could produce beats in the video signal emitted by the card. This is because this video signal is itself being clocked at a frame frequency of, for example, 100 Hz, at a row frequency that is, for example, of the order of 80 kHz, and at a pixel frequency that is, for example, of the order of 50 MHz. The noise from the switched-mode power supply includes components at harmonic frequencies of the chopping frequency and can typically generate beats related to the pixel frequency; these beats can be seen in the video image when it is reproduced on a screen. They are a nuisance in certain applications in which the image quality needs to be very high.

These fluctuations cannot be eliminated because they are not stationary because of the fact that the frequency of switched-mode power supplies and their switching duty cycle fluctuates permanently.

For top-end applications, there would be a need to limit the video signal fluctuations to a few microvolts for a video signal with a maximum amplitude of 1 volt. The output voltage from a switched-mode power supply cannot in practice be filtered so as to limit the residual ripple to a few microvolts, without using extremely bulky components.

To avoid this image degradation, it has already been proposed to use in this context switched-mode power supplies that include a synchronization input. Such synchronizable switched-mode power supplies do exist. The synchronization input should typically receive synchronization signals at a frequency that is lower than the chopping frequency; this input is used to realign the chopping signals when they are out of phase relative to the synchronization signals.

The switched-mode power supply is then synchronized, for example to a frequency of approximately 2 MHz that can be found in the clock circuits of the card. This frequency is a submultiple of the pixel frequency and a multiple of the row frequency, and the beats disappear.

However, another phenomenon then appears, which is a fixed image noise (or “Fixed Pattern Noise”, FPN) which is induced by the variations of the output voltage from the switched-mode power supply while reading a row of pixels: the voltage ripples a little at the chopping frequency, and several ripples occur during a row and on each row. A ripple pattern appears visibly in the image; it represents the residual ripple of the power supply voltage supplied by the switched-mode power supply. This fixed noise can theoretically be eliminated by a software correction (storing the fixed noise in memory and subtracting the stored noise). However, in practice the fixed noise varies over time, as a function of the fluctuations in the general power supply voltage and temperature.

### SUMMARY OF THE INVENTION

To limit the degradation of the video signal due to the use of switched-mode power supplies, the invention proposes using a chopping frequency for the switched-mode power supply that is the pixel reading frequency of the sensor, and not a submultiple of this frequency. Not only are no beats possible, but there is no longer any FPN-type noise. This use of the pixel frequency for the switched-mode power supply will be used for the power supplies that are critical to the production of a quality video signal, and in particular the power supply that is used in the amplifier for reading the signals coming from the pixels.

In an application to sensors in CCD (Charge-Coupled Device) technology, the charges generated by the light are transferred into a read diode which converts them into a voltage read by a read amplifier; the power supply to which the invention relates is that which supplies the power supply voltage and a reference voltage for this diode and for the read amplifier. Typically, the power supply is a voltage step-up switched-mode power supply receiving a general voltage of 12 volts and producing a voltage of approximately 15 volts.

Thus, the invention proposes an image sensor system comprising an integrated circuit chip incorporating a matrix of rows and columns of photosensitive pixels and a read amplifier, the amplifier supplying successive signals representing the lighting of the different pixels of the image, with a pixel reading frequency determined by a system clock, the system being powered by a general power supply voltage and the read amplifier being powered by a stabilized power supply voltage supplied by a DC/DC voltage converter receiving the general power supply voltage, the voltage converter comprising a switched-mode power supply that uses a switch to chop a direct current at high frequency and a rectifier to rectify and filter the chopped current, characterized in that the switch receives a periodic control signal at the pixel reading frequency to perform the chopping at this frequency.

Preferably, the switched-mode power supply in question works with a fixed switching duty cycle and this duty cycle is preferably close to 50% or equal to 50%.

The switched-mode power supply may be followed by a linear voltage regulator. It can also be preceded by a linear regulator that lowers the general power supply voltage of the system.

In addition to the stabilized power supply voltage mentioned above, the chip can also receive a reference voltage that is useful in reading the signals coming from the matrix, this reference voltage being produced by voltage division from the stabilized voltage supplied by the DC/DC converter.

The switch of the switched-mode power supply may be a power MOS transistor receiving on its gate the control signal at the pixel reading frequency and having its source connected to a ground and its drain connected to an inductive element, the inductive element being connected to the input of the rectifier, said rectifier comprising at least one rectifying diode and a filtering capacitor.

In one embodiment, the inductive element is an inductor connected between the drain of the transistor and a primary power supply voltage, and the junction point of the inductor and of the drain of the transistor is connected to the input of the rectifier. In another embodiment, the inductive element is an autotransformer connected between a primary power supply voltage and the drain of the transistor, and an intermediate tap of the autotransformer is connected to the input of the rectifier. The charge of the switching transistor can also be an LC resonant circuit.

The pixel frequency is preferably between 10 MHz and 50 MHz.

The switched-mode power supply can include a circuit for preventing current from entering the switch in the absence of a periodic signal controlling the switch. This circuit can comprise a transistor in series between the power supply and the inductive element, and a peak detector receiving the control signal at the pixel reading frequency, the peak detector allowing this transistor to conduct only if the periodic control signal is present.

The sensor system can comprise several DC/DC converters supplying different DC voltages to power different parts of the system, and in particular logic circuits for controlling the matrix of photodetectors. In this case, these other converters use conventional switched-mode power supplies with a lower frequency and a variable duty cycle. Only the power supply which supplies stable reference voltages to the read circuits works at the pixel reading frequency; it supplies a small portion of the power consumed by the system, the other power supplies supplying most of the power but having little influence on the quality of the video signal.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF DRAWINGS

The present invention is illustrated by way of example, and not by limitation, in the figures of the accompanying drawings, wherein elements having the same reference numeral designations represent like elements throughout and wherein:

FIG. 1 represents the general architecture of an electronic card on which are mounted various components forming an electronic image capture system;

FIG. 2 represents the DC/DC voltage converter with its switched-mode power supply working at the pixel reading frequency;

FIG. 3 represents an exemplary linear regulation circuit downstream of the switched-mode power supply;

FIG. 4 represents an alternative embodiment of the switched-mode power supply;

FIG. 5 represents an embodiment of the switched-mode power supply with inhibition by a detector that detects the presence or absence of the switching control signal.

### DESCRIPTION OF PREFERRED EMBODIMENTS

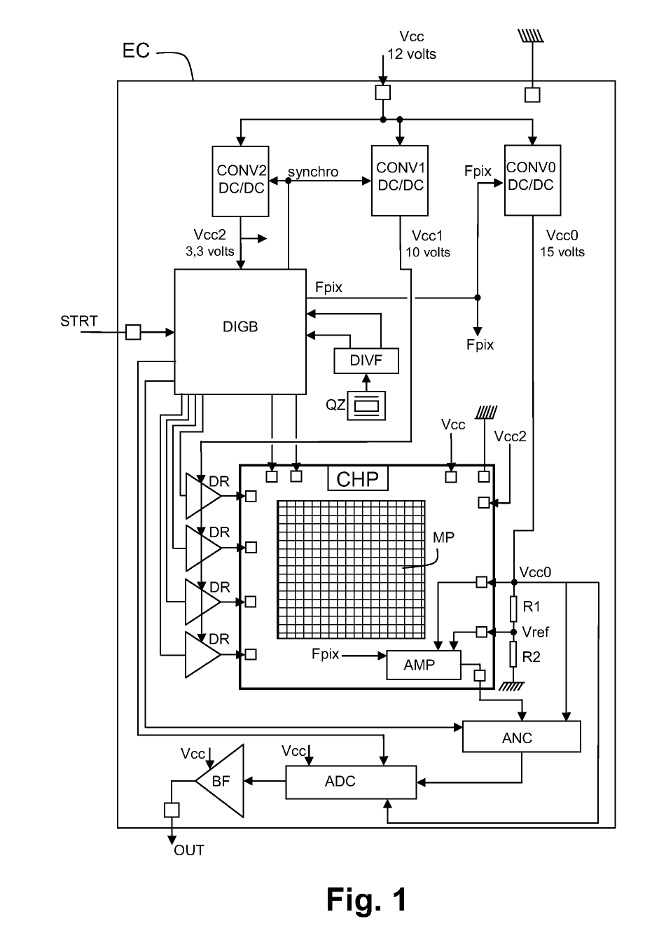

FIG. 1 shows the general architecture of the image capture system. The system comprises an electronic card EC, the core of which is a monolithic image detection chip, designated by the reference CHP. The top surface of the chip is intended to be mounted in the focal plane of a focussing optics system that is not shown which projects the image to be detected onto the chip.

The chip CHP mainly comprises a matrix MP of pixels arranged in rows and columns, internal peripheral electronic circuits (not shown) to enable the matrix to operate, input terminals to allow control from outside the chip, power supply and ground terminals, and at least one read amplifier AMP to establish an analogue signal that represents the charges detected in each pixel of the matrix. In the example shown, the amplifier AMP supplies an analogue signal to an output terminal of the chip, but provision could also be made for the chip to include an analogue/digital converter to output a digital signal.

The electronic card EC includes, in addition to the chip CHP,
digital circuits grouped together in the diagram under the reference DIGB; these circuits notably generate digital control signals for controlling the rows and columns of the chip CHP;
amplifiers (or “drivers”) DR that receive these signals from the block DIGB and apply them to the control input terminals of the chip;
a quartz crystal oscillator QZ and one or more frequency dividers DIVF for producing basic frequencies for the operation of the block of digital circuits DIGB; the quartz crystal oscillator for example supplies a frequency that is a multiple of the output rate of the pixels in the video signal; for example, for a pixel frequency of 40 MHz, the quartz crystal oscillator can supply a frequency of 120 MHz and the frequency divider can supply different submultiples of this frequency, and notably the read frequency Fpix defining the output rate of the pixels; the signal at the frequency Fpix can also be prepared inside the block of digital circuits DIGB;
power supply blocks supplying various power supply voltages Vcc0, Vcc1, Vcc2 to different parts of the electronic card; these blocks are DC/DC converters CONV0, CONV1, CONV2 receiving the general power supply voltage Vcc of the electronic card, and they are preferably implemented using switched-mode power supplies, to minimize energy consumption and, for some of them, to be able to produce higher voltages than the general power supply voltage Vcc;
analogue signal processing circuits ANC, receiving the analogue output from the chip (supplied by the output amplifier AMP) when the chip supplies the image information in analogue form;
an analogue/digital converter ADC receiving the output from the analogue processing circuits ANC and supplying successive digital signals representing the information coming from each pixel; the converter ADC operates at the pixel reading frequency Fpix;
a buffer amplifier BF receives the digital data stream from the converter ADC, to apply it to an output OUT of the card; the output is shown here as a single terminal that can be used to transmit a serial binary stream, but it goes without saying that, in the case where the digital information is supplied in the form of words in parallel, the output terminal OUT consists in reality of a number of terminals equal to the number of bits in the words supplied; the words are supplied at the rate Fpix;
the electronic card EC can even include an input STRT to which a start signal will be applied; until it receives this signal, the card remains idle in a low-power standby position.

In the example shown, it is assumed that the sensor chip CHP is a CCD technology chip, but the invention can also be applied to an MOS technology sensor. In the CCD technology, the pixels collect charges generated by the light and transfer them vertically from row to row to a horizontal read register placed at the foot of the matrix; the charges collected by the read register are read rapidly between two row shifts by shifting them horizontally within the register and transferring them into a read diode; the amplifier AMP reads the charges transferred in succession into the read diode, at a rate that is the pixel frequency Fpix, typically of the order of 40 MHz.

In this CCD technology, several power supply voltages will typically be needed; the block of digital circuits DIGB is produced using CMOS technology and may use a power supply voltage Vcc2 of 3.3 volts which does not need to be very stable; the signals controlling the shift phases of the registers, by column or by row, are applied by the drivers DR which use a power supply voltage Vcc1 of 10 volts; this voltage also does not need to be very stable; the read amplifier AMP uses a power supply voltage Vcc0 of 15 volts which must be particularly stable and a reference voltage Vref which may be of the order of 10 volts and which must also be particularly stable; the voltage Vref can be produced from the voltage Vcc0, by a resistive divider R1,R2. The analogue processing circuits ANC and the analogue/digital converter may also use a particularly stable reference voltage which may be Vcc0.

The chip itself receives the voltage Vcc0 and the voltage Vref and can also receive the general voltage Vcc of 12 volts and the voltage Vcc2 of 3.3 volts.

Conventionally, DC/DC converters are made from switched-mode power supplies. Each converter in principle has an internal oscillator which supplies the chopping frequency for the input direct current. The chopping frequencies can be a few tens of kilohertz. The switched-mode power supplies may have a synchronization input (synchro in FIG. 1); this input receives a lower frequency which may come from the block of digital circuits or from outside the card, and the frequency of the oscillator of the switched-mode power supply aligns its phase (not its frequency) with the phase of the synchronization signal.

According to the invention, provision is made for one of the DC/DC converters to be produced differently from the others. More specifically, the DC/DC converter CONV0 must supply a particularly stable voltage Vcc0 (and a reference voltage Vref) intended for the read amplifier AMP and possibly intended for the analogue/digital converter ADC. This converter CONV0 does not include an internal oscillator or a synchronization input, but it receives, directly from the digital block DIGB (or from the frequency divider DIVF), the frequency Fpix which represents the output rate of the pixels.

The chopping frequency is the frequency Fpix and this is applied to a switch (MOS transistor) which performs the chopping. In a preferred version, the chopping signal has a fixed duty cycle of 50%, that is to say that it can come directly from the frequency divider DIVF with no particular processing tending to modify its duty cycle.

FIG. 2 shows the preferred principle for producing the DC/DC converter CONV0, in the case where the voltage to be produced Vcc0 is higher (15 volts for example) than the general power supply voltage Vcc (12 volts for example). The converter here preferably consists of a voltage step-up switched-mode power supply ALD, which produces a voltage Vcc′0, followed by a linear voltage regulator REG with a small voltage drop which lowers the voltage from Vcc′0 to Vcc0. The use of a linear voltage regulator to finely tune the voltage Vcc0 poses no excessive power consumption problems, because the power delivered by this converter CONV0 is low: in practice, it powers only the read amplifier AMP and the voltage references necessary for reading video signals and for the analogue/digital converter; it does not power the circuits of the digital block DIGB nor does it power the amplifiers (drivers) DR controlling the charge transfer phases of the chip. The power supplied by the converter CONV0 is low, so the power loss in the linear regulator is low.

The switched-mode power supply, in a very simple version, comprises an MOS transistor T1 which constitutes the current chopping switch. The transistor T1 receives, directly on its gate, the clock at the frequency Fpix. Its source is grounded and its drain is connected to an inductive element L1 which receives the general power supply voltage Vcc. The transistor T1 chops, at the frequency Fpix, the current flowing through the inductive element L1. The drain of the transistor is connected to a rectifying diode D1. The diode is connected to the output of the switched-mode power supply. This is preferably a diode with a low threshold voltage (a Schottky diode for example with metal/semiconductor contact). A capacitor C1, placed between the output at Vcc′0 and ground, is used to smooth the variations of the output voltage Vcc′0.

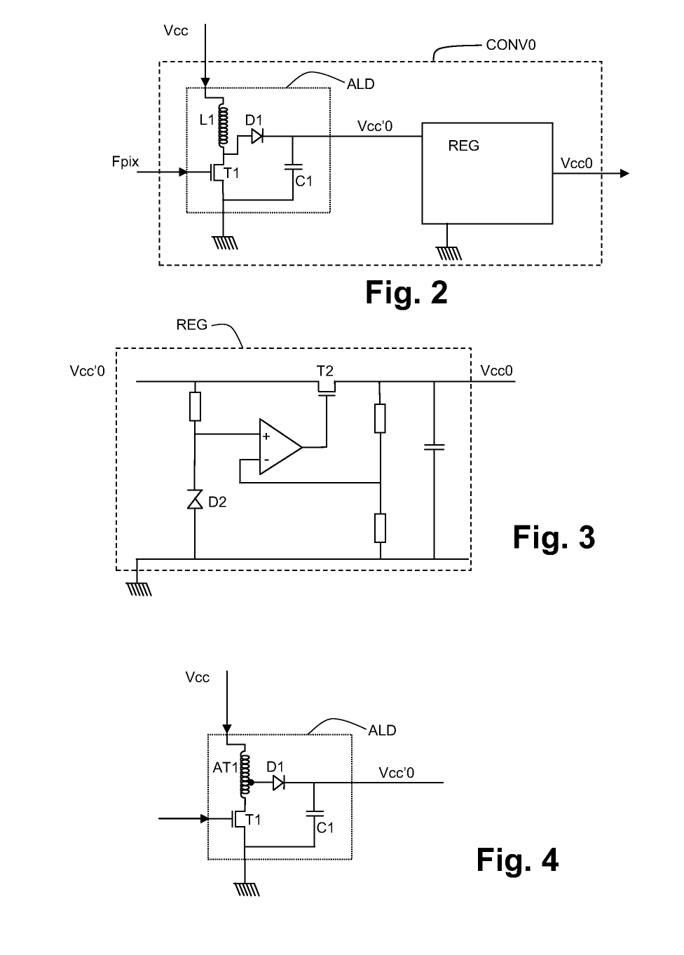

The linear regulator REG, placed downstream of the power supply ALD, can be of conventional construction, and an example is given by way of illustration in FIG. 3 with a zener diode D2 fixing the voltage at the non-inverting input of an operational amplifier, a ballast transistor T2 for making the voltage drop from Vcc′0 to Vcc0, and feedback from the output at the voltage Vcc0 to the inverting input of the amplifier, via a resistive divider bridge, to maintain the output voltage Vcc0 at a value that is imposed as a function of the voltage of the zener diode and the division ratio of the resistive bridge. Other linear regulator schemes are possible. The power loss is defined by the current consumed by the circuits downstream of the regulator, multiplied by the difference Vcc′0 −Vcc0.

FIG. 4 shows a variant embodiment of the switched-mode power supply ALD, in which the inductive element consists of an autotransformer (AT1) placed in series between the power supply Vcc and the drain of the transistor T1. The rectifier D1 is connected to an intermediate tap of the autotransformer, which makes it possible to define the desired output voltage Vcc′0 without varying the duty cycle of the switching control signal at the frequency Fpix. The duty cycle can then be chosen to be equal to 50%, which is the simplest solution. A downstream linear voltage regulator is not necessary but can be provided.

In an advantageous embodiment, a detector detecting the presence of the read frequency Fpix on the gate of the chopping transistor is added to the switched-mode power supply, so as to interrupt the current supply to the inductive element L1 if the clock frequency Fpix is not present. This makes it possible to avoid unnecessary power consumption when the circuit is idle (before the application of a general start command for the electronic card on the input STRT) and thus primarily makes it possible to avoid damaging the transistor T1 on start up.

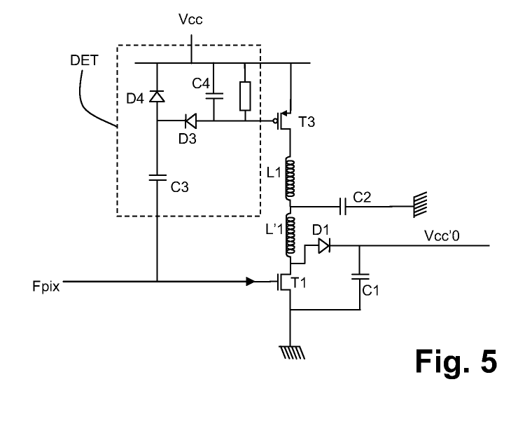

FIG. 5 represents the switched-mode power supply provided with this Fpix presence detector. Elements that are common to those of FIG. 2 are given the same references and will not be described again.

In this example, the inductive element consists of two inductors in series L1 and L′1 having a junction point connected by a capacitor C2 to ground. The inductive element is connected by a switch transistor T3 (in this case, a PMOS transistor) to the power supply Vcc and receives current only when this transistor is conducting.

A peak detector DET, consisting of two capacitors C3 and C4, two diodes D3 and D4, and a resistor, establishes on the gate of the transistor T3 a DC voltage sufficiently less than Vcc when the frequency Fpix is present, and returns this voltage on the gate to Vcc when the frequency Fpix is no longer present. In the first case, it allows the transistor T3 to conduct; in the second case, it prevents the passage of current towards the inductive element.

Typically, if the voltage Vcc is 12 volts and if the clock signal is a signal between 0 volt and 3.3 volts peak-to-peak, a potential of approximately 9 volts appears on the gate of the transistor T3 which is low enough to render this transistor (which is a PMOS transistor) conductive.

In the preceding figures, the chopping of a current passing through an inductive element (inductor or autotransformer) has been described; it would also be possible to consider having the inductive element associated with a capacitor to form a resonant circuit LC as a load for the switching transistor, notably if the pixel frequency is very high.

The switched-mode power supply described above does not include an oscillator to produce the chopping frequency and does not use any system for adjusting the switching duty cycle. It would, however, be possible to use a duty cycle adjustment as is often done in switched-mode power supplies. In this case, the square clock signal at the frequency Fpix would be transformed into a substantially sawtooth signal at this frequency, and this sawtooth signal would be applied to an input of a comparator whose second input would receive a voltage representative of the output voltage of the power supply and between the low and high levels of the sawtooth. The output from the comparator then controls the switching and the duty cycle can be adjusted by the relative adjustment between the levels of this sawtooth voltage and the level that is compared to the sawtooth. This solution is, however, less simple than the one described previously.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. An image sensor system comprising an integrated circuit chip incorporating a matrix of rows and columns of photosensitive pixels and a read amplifier, the amplifier supplying successive signals representing the lighting of the different pixels of the image, with a pixel reading frequency determined by a system clock, the system being powered by a general power supply voltage and the read amplifier being powered by a stabilized power supply voltage supplied by a DC/DC voltage converter receiving the general power supply voltage, the DC/DC voltage converter comprising a switched-mode power supply that uses a switch to chop a direct current at high frequency and a rectifier to rectify and filter the chopped current, characterized in that the switch receives a periodic control signal at the pixel reading frequency to perform the chopping at this frequency.

2. The image sensor system according to claim 1, wherein the duty cycle of the switch control signal is fixed.

3. The image sensor system according to claim 2, wherein the duty cycle is close to 50% or equal to 50%.

4. The sensor system according to claim 1, wherein the DC/DC converter comprises, in addition to the switched-mode power supply, a linear voltage regulator that lowers the voltage at the output of the rectifier.

5. The image sensor system according to claim 1, wherein the switch is an MOS transistor receiving on its gate the control signal at the pixel reading frequency and having its source connected to a ground and its drain connected to an inductive element, the inductive element being connected to the input of the rectifier, said rectifier comprising at least one rectifying diode and a capacitor.

6. The image sensor system according to claim 5, wherein the inductive element is an inductor connected between the drain of the transistor and a power supply voltage, and the junction point of the inductor and of the drain of the transistor is connected to the input of the rectifier.

7. The image sensor system according to claim 5, wherein the inductive element is an autotransformer connected between a power supply voltage and the drain of the transistor, and an intermediate tap of the autotransformer is connected to the input of the rectifier.

8. The image sensor system according to claim 5, wherein the inductive element is associated with a capacitive element forming a resonant circuit connected to the drain of the transistor.

9. The image sensor system according to claim 5, wherein the switched-mode power supply includes a circuit for preventing current from entering the switch in the absence of a signal controlling the switch.

10. The image sensor system according to claim 9, wherein the circuit for preventing the passage of current comprises a transistor in series between the power supply and the inductive element, and a peak detector receiving the control signal at the pixel reading frequency, the peak detector allowing this transistor to conduct only if the control signal is present.

11. The image sensor system according to claim 1, wherein it includes logic circuits for controlling the matrix of photodetectors, these circuits being powered by other switched-mode power supply converters operating at different frequencies from the pixel reading frequency and with variable duty cycles.

12. The image sensor system according to claim 2, wherein the DC/DC converter comprises, in addition to the switched-mode power supply, a linear voltage regulator that lowers the voltage at the output of the rectifier.

13. The image sensor system according to claim 3, wherein the DC/DC converter comprises, in addition to the switched-mode power supply, a linear voltage regulator that lowers the voltage at the output of the rectifier.
